(19) United States
(12) Patent Application Publication
(10) Pub. No.: US 2003/0079570 A1
(43) Pub. Date: May 1, 2003

(54) Structure of multi-directional, combination-type ratchet wheel wrench with sleeve

(76) Inventor: Chun-Chiung Chen, Taipei City (TW)

Correspondence Address: Chun-Chiung Chen, P.O. Box 82-144, Taipei, TW

(21) Appl. No.: 09/986,517

(22) Filed: Nov. 1, 2001

(51) Int. Cl. B25B 13/46

(52) U.S. Cl. 81/60

(57) ABSTRACT

A structure of multi-directional, combination-type ratchet wheel wrench with sleeve is disclosed. The structure comprises an elongated handle having a hexagonal opening each at the end thereof, wherein a ratchet wheel is mounted within the hexagonal opening and is controlled to move clockwise and counterclockwise and a single corner wall of the hexagonal opening is slightly retracted and the top and bottom ends of the corner end face are slightly recessed, and a slot is formed between two recesses; a convex-shaped spring engaged onto the corner wall with a top and a bottom bent section of the spring being engaged with the slot, forming a center slightly protruded section of the spring urging the corner wall; and a sleeve with through opening at both ends thereof and of hexagonal opening of different size, and having a step-like structure, the structure being adaptable to the hexagonal openings at the end of the elongated handle; thereby the ratchet wheel wrench with sleeves of different sizes combined at the end of the hexagonal openings of the wrench is used to tighten or loosen nuts with same sizes as that of the hexagonal opening of the sleeve.

### BACKGROUND OF THE INVENTION

(a) Technical Field

The present invention relates to a structure of a multi-directional, combination-type ratchet wrench with multi-direction with sleeves.

(b) Brief Description of the Prior Art

Ratchet wheel wrench is a tool used for dismantling studs or nuts. A general type of ratchet wheel wrench is wrench with an opened end, a hexagon end or opened ends with sleeve. The different standards and combinations will solely depend on shapes and sizes of studs and nuts. The wrench has one end of the handle formed into an open ended, and the other end of the handle is mounted with a ratchet sleeve module, and sleeves are provided. The external edge of the sleeve can cap a stud, or a nut which is formed into a ratchet face. The handle relative to one internal edge of the sleeve is provided with a retainer which contains a smaller ratchet block. The behind of the ratchet block is supported with a spring element. When the wrench is turned in a clockwise direction, the highest point of the ratchet block can engage with the ratchet face of the sleeve so that the sleeve can turn the stud or the nut. Otherwise, when the wrench turns in a reverse direction, the ratchet face of the sleeve will push the ratchet block so as to move towards to a slightly larger side of the retainer so that the sleeve will not be restricted by the ratchet block and it becomes an empty turning. Thus, it is convenience in operation for the user. However, the drawback of this conventional wrench is that the size of the wrench opening at the end of the wrench is fixed and only a specific size of sleeve can be used. Thus it is a waste to have a plurality of wrenches to comply with the different size sleeves.

### SUMMARY OF THE INVENTION

It is an object of the present invention to overcome or ameliorate at least one of the disadvantages of the prior art, or to provide a useful alternative.

According to a first aspect of the invention, there is provided a structure of a multi-directional, combination-type ratchet wheel wrench with sleeve, comprising an elongated handle having a hexagonal opening each at the end thereof, wherein a ratchet wheel is mounted within the hexagonal opening and is controlled to move clockwise and counterclockwise and a single corner wall of the hexagonal opening is slightly retracted and the top and bottom ends of the corner end face are slightly recessed, and a slot is formed between two recesses; a convex-shaped spring engaged onto the corner wall with a top and a bottom bent section of the spring being engaged with the slot, forming a center slightly protruded section of the spring urging the corner wall; and a sleeve with through opening at both ends thereof and of hexagonal opening of different size, and having a step-like structure, the structure being adaptable to the hexagonal openings at the end of the elongated handle; thereby the ratchet wheel wrench with sleeves of different sizes combined at the end of the hexagonal openings of the wrench is used to tighten or loosen nuts with same sizes as that of the hexagonal opening of the sleeve.

Yet another aspect of the present invention is to provide a structure of a multi-directional, combination-type ratchet wheel wrench with sleeve, wherein the opening at the ends of the elongated handle is twelve-sided polygonal shape.

A further aspect of the invention is to provide a structure of a multi-directional, combination-type ratchet wheel wrench with sleeve, wherein the opening of the sleeve is dodecagon shape.

Still a further aspect of the invention is to provide a structure of a multi-directional, combination-type ratchet wheel wrench with sleeve, wherein a single corner wall or the corner wall of corresponding sides or the corner wall of the equilateral side within the hexagonal opening of the elongated handle is slightly retractable and the top and bottom ends of the end face of the corner wall are slightly recessed, and a slot is formed between two recesses, and each of the corner wall or the corner wall of corresponding sides or corner wall of the equilateral side is provided with a convex-shaped spring for the positioning of a single face or the corresponding sides or the equilateral sides of the hexagonal shaped sleeve.

Still another aspect of the invention is to provide a structure of a multi-directional, combination-type ratchet wheel wrench with sleeve, wherein a recessed groove is provided to the middle section of the sleeve shaft, and a rubber rim is mounted within the recessed groove as a structure for engagement.

### BRIEF DESCRIPTION OF THE DRAWINGS

FIG. 1 is a perspective view of a single wrench in accordance with the present invention.

FIG. 2A is a perspective view of a portion of FIG. 1;

FIGS. 2B and 2C illustrate sectional views (in vertical and in horizontal direction) of the wrench of FIG. 1.

FIG. 3 is exploded perspective view of the ratchet wheel wrench in accordance with the present invention.

FIG. 4 is a perspective view of sleeve of the present invention.

FIG. 5 is a sectional view of the sleeve of FIG. 4 in accordance with the present invention.

FIG. 6 is a perspective view of the ratchet wheel wrench having mounted with sleeve at the end thereof, in accordance with the present invention.

FIG. 7A is perspective view of a portion of FIG. 1;

FIG. 7B illustrates a vertical sectional view of the sleeve mounted to the end of the ratchet wrench of FIG. 6.

FIG. 8 is a perspective view of another preferred embodiment of the ratchet wheel wrench in accordance with the present invention.

FIGS. 9A, 9B, 9C, 9D, 9E and 9F show perspective views of the sleeves in accordance with the present invention.

FIG. 10 is a perspective view of the ratchet wheel wrench of the second preferred embodiment having mounted with sleeves at the end thereof

FIGS. 11A, 11B, 11C and 11D show perspective views of other preferred sleeves in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

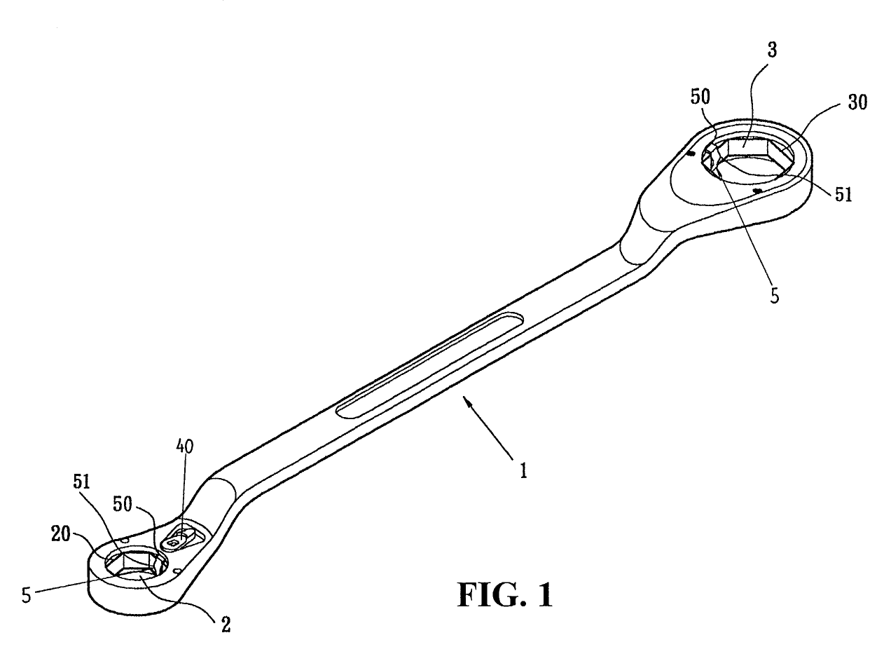

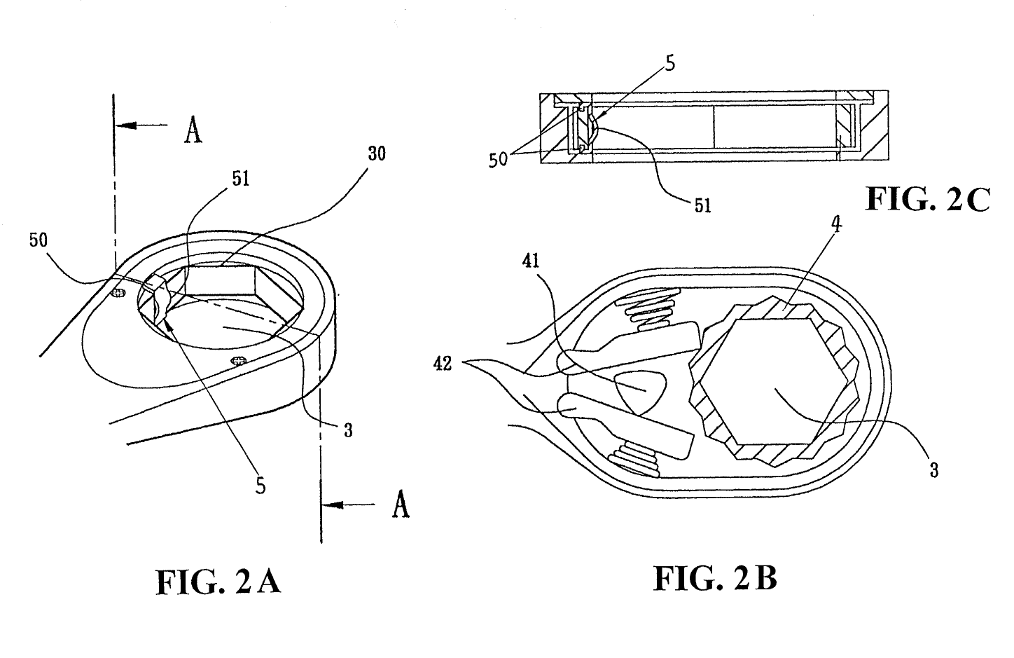

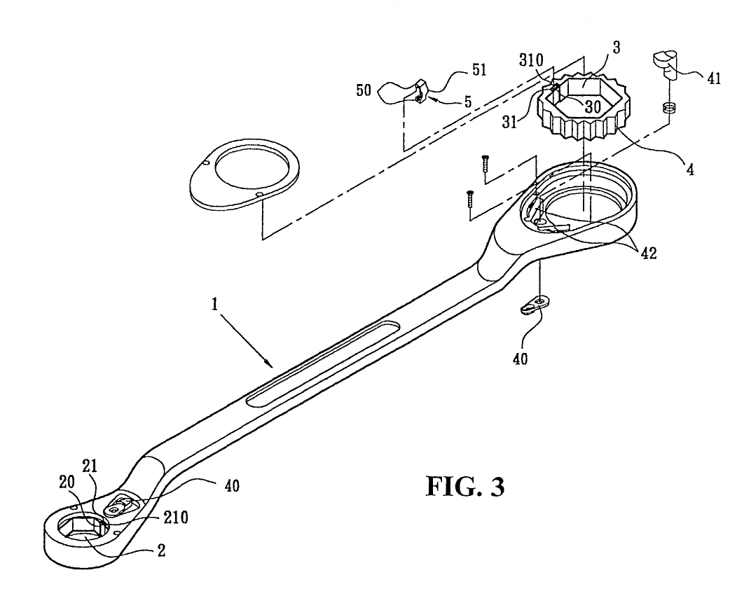

Referring to FIGS. 1, 2A, 2B, and 3, there is shown a structure of a multi-directional, combination-type ratchet wheel wrench with sleeve, comprising an elongated handle 1 having a hexagonal opening 2, 3 each at the end thereof, wherein a ratchet wheel 4 is mounted within the hexagonal opening 2, 3 and is controlled to move clockwise and counterclockwise by a triggering button 40 to trigger a top block 41 to urge a left and a right stop 42, and a single corner wall 20, 30 of the hexagonal opening 2, 3 is slightly retracted and the top and bottom ends of the corner wall 20, 30 are slightly recessed, and a slot 210, 310 is formed between two recesses 21, 31; a convex-shaped spring 5 engaged onto the corner wall 20, 30 with a top and a bottom bent section 50 of the spring 5 being engaged with the slot 210, 310, forming a center slightly protruded section 51 of the spring 5 urging the corner wall 20, 30 of the hexagonal opening 2, 3.

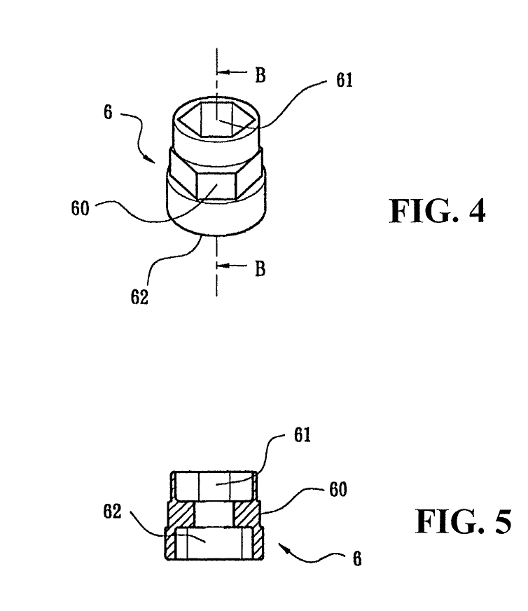

Referring to FIGS. 4 and 5, a sleeve 6 with through opening 61, 62 at both ends thereof and of hexagonal opening 61, 62 of different size, and having a step-like structure with a hexagonal shaft 60, the structure being adaptable to the hexagonal openings 61, 62 at the end of the elongated handle 1; thereby the ratchet wheel wrench with sleeves of different sizes combined at the end of the hexagonal openings of the wrench is used to tighten or loosen nuts with same sizes as that of the hexagonal opening of the sleeve. In accordance with the present invention, the hexagonal opening is of size 14 mm and 19 mm

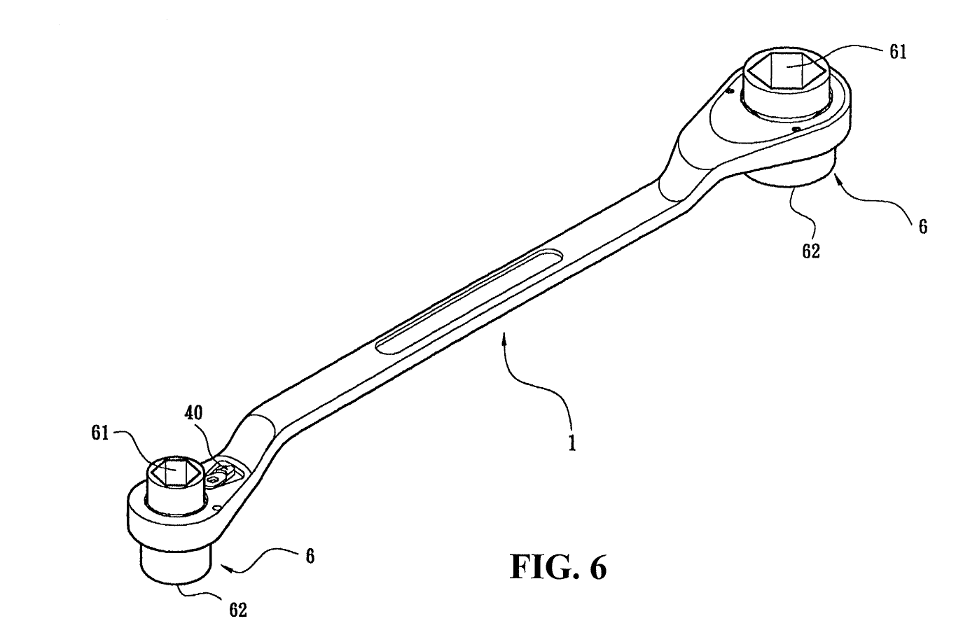

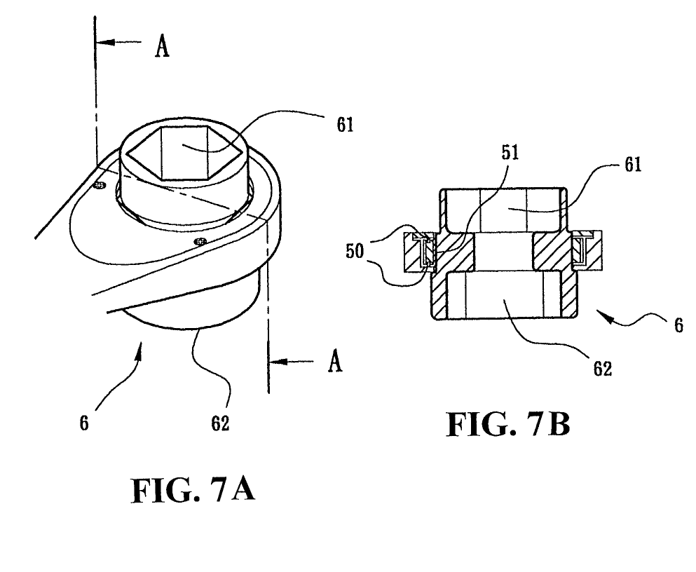

As shown in FIGS. 6, 7A and 7B, the two ends of the elongated handle 1 are provided with a hexagonal opening 2, 3 and the sizes of the openings 2, 3 are different from one another and are adaptable to sleeve 6 of the same size similar to the size of the openings 2, 3. The shaft of the sleeve 6 is fitted at the two openings 2, 3. By means of the protruded section 51 of the center region of the spring 5 at the corner wall 20, 30 within the opening 2, 3 to change slightly to engage with the sleeve 6, the ratchet wheel wrench can be used together with a variety of different size sleeve 6.

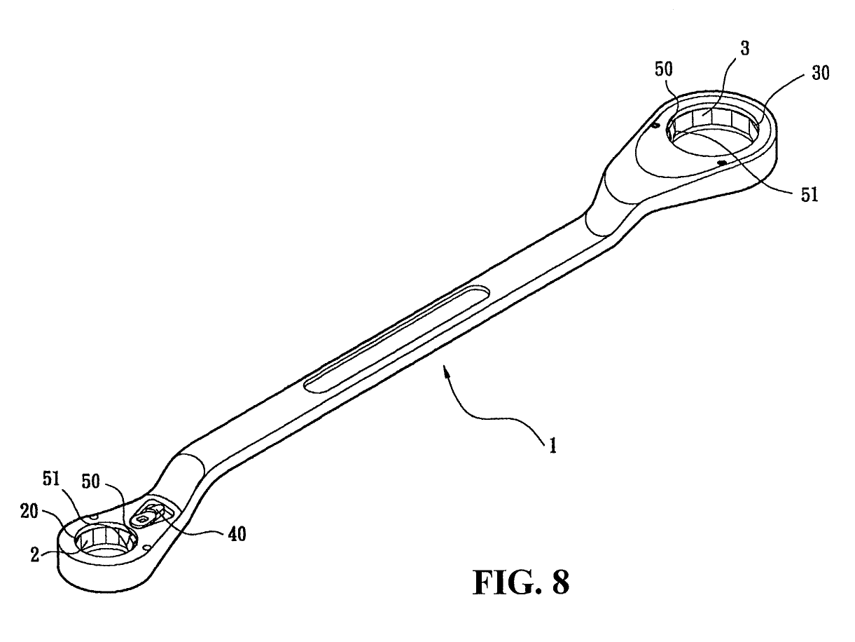

Referring to FIG. 8, there is shown another preferred embodiment of a structure of multi-directional, combination-type ratchet wheel wrench with sleeve, wherein the openings at the ends of the elongated handle 1 are twelve-sided polygon openings 11, 12.

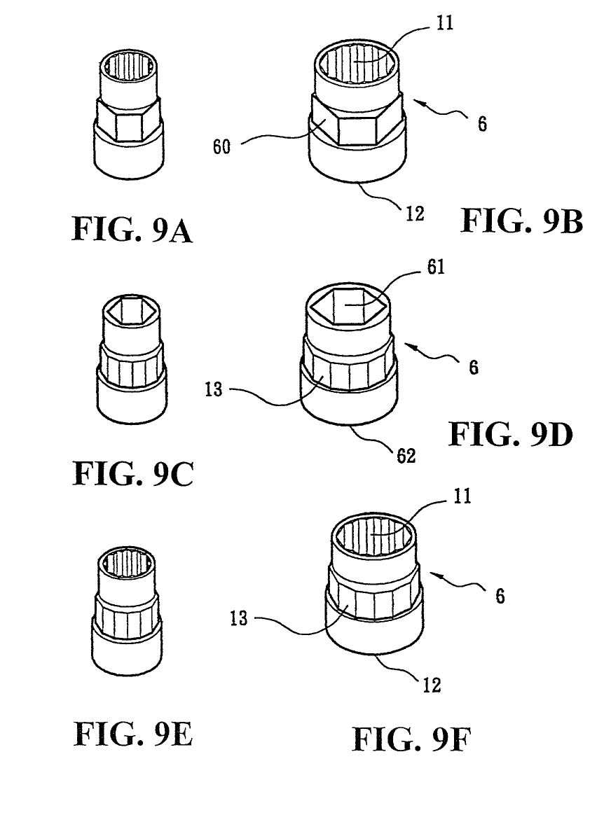

Referring to FIGS. 9A, 9B, 9C, 9D, 9E and 9F, there is shown the structure of a sleeve 60 with a hexagonal shape shaft 60, and the opening of the sleeve is twelve-sided polygonal shape 11, 12 (referring to FIG. 9A).

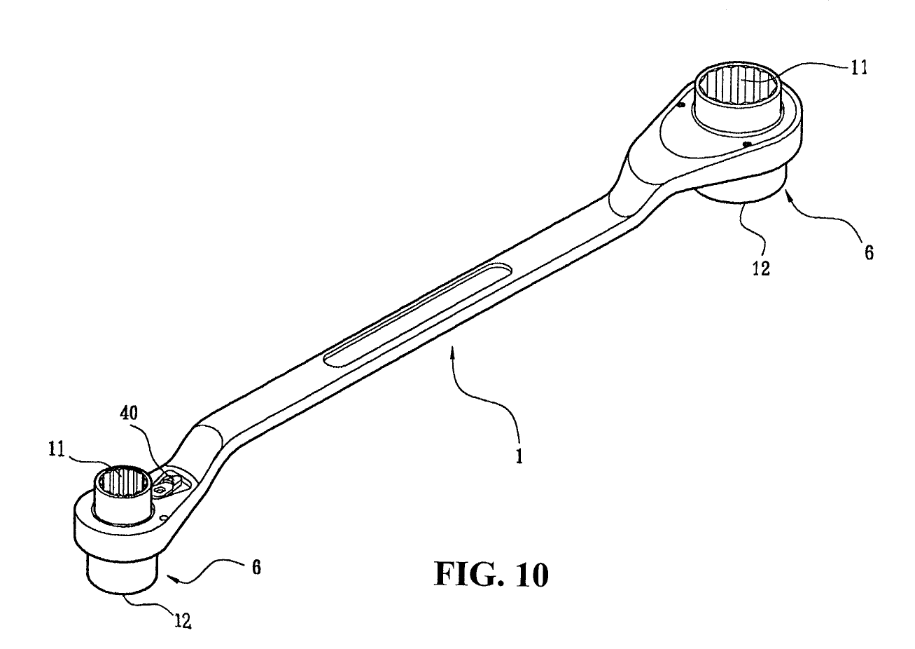

Further the shaft 13 can be made into a structure of twelve-sided polygonal shape (referring to FIGS. 9B, C). The combination of the sleeve together with the opening is shown in FIG. 10.

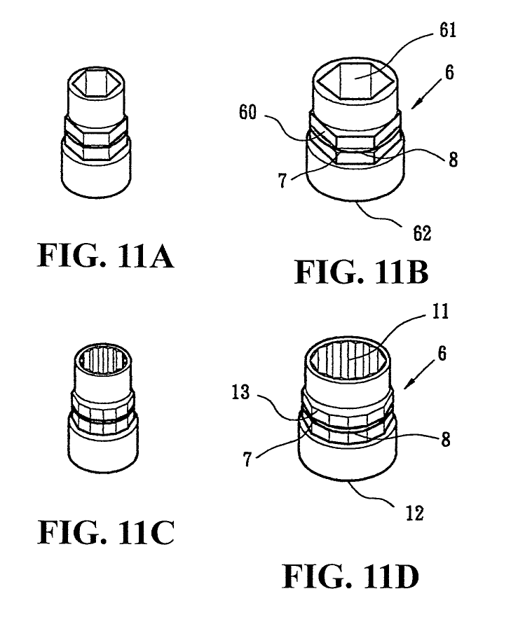

Referring to FIGS. 11A, 11B, 11C and 11D, there is shown another structure of the sleeve, wherein the top of the shaft 13 is provided with a rim recess 7 to mount with a rubber rim 8, such that if the spring for positioning with the sleeve cannot be mounted at the two ends of the elongated handle, there is another structure for engagement.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only the scope of the appended claims.

I claim:

1. A structure of a multi-directional, combination-type ratchet wheel wrench with sleeve, comprising:
an elongated handle having a hexagonal opening each at the end thereof, wherein a ratchet wheel is mounted within the hexagonal opening and is controlled to move clockwise and counterclockwise and a single corner wall of the hexagonal opening is slightly retracted and the top and bottom ends of the corner end face are slightly recessed, and a slot is formed between two recesses;
a convex-shaped spring engaged onto the corner wall with a top and a bottom bent section of the spring being engaged with the slot, forming a center slightly protruded section of the spring urging the corner wall; and
a sleeve with through opening at both ends thereof and of hexagonal opening of different size, and having a step-like structure, the structure being adaptable to the hexagonal openings at the end of the elongated handle; thereby
the ratchet wheel wrench with sleeves of different sizes combined at the end of the hexagonal openings of the wrench is used to tighten or loosen nuts with same sizes as that of the hexagonal opening of the sleeve.

2. The structure of a multi-directional, combination-type ratchet wheel wrench with sleeve of claim 1, wherein the opening at the ends of the elongated handle is a dodecagon shape.

3. A structure of a multi-directional, combination-type ratchet wheel wrench with sleeve of claim 1, wherein the opening of the sleeve is dodecagon shape.

4. A structure of a multi-directional, combination-type ratchet wheel wrench with sleeve of claim 1, wherein a single corner wall or the corner wall of corresponding sides or the corner wall of the equilateral side within the hexagonal opening of the elongated handle is slightly retractable and the top and bottom ends of the end face of the corner wall are slightly recessed, and a slot is formed between two recesses, and each of the corner wall or the corner wall of corresponding sides or corner wall of the equilateral side is provided with a convex-shaped spring for the positioning of a single face or the corresponding sides or the equilateral sides of the hexagonal shaped sleeve.

5. A structure of a multi-directional, combination-type ratchet wheel wrench with sleeve of claim 1, wherein a recessed groove is provided to the middle section of the sleeve shaft, and a rubber rim is mounted within the recessed groove as a structure for engagement.
